(19) United States
(12) Patent Application Publication
(10) Pub. No.: US 2012/0115435 A1
(43) Pub. Date: May 10, 2012

(54) Privacy in Mobile Device Communications

(75) Inventor: Gilad Oren, Tel Aviv (IL)

(73) Assignee: Microsoft Corporation, Redmond, WA (US)

(21) Appl. No.: 12/942,667

(22) Filed: Nov. 9, 2010

(51) Int. Cl. H04M 3/16; G06F 21/00

(52) U.S. Cl. 455/410; 726/26

(57) ABSTRACT

The subject disclosure is directed towards mobile device privacy and anonymity. When a contact is marked as private, or when a device operates in a private mode, one or more privacy-related actions with respect to an incoming or outgoing communication are performed. Privacy-related actions include logging private telephone call information to a private, protected log, storing private message content to a private protected store, or not saving any such information or content. Another privacy-related action comprises not allowing a visible or audible notification to occur when a private communication is received.

### BACKGROUND

Privacy and anonymity are desired by users with respect to their mobile communications, e.g., telephone calls, SMS/MMS (text or other such messages), emails, instant messages, social networking communications and so forth. For example, some people do not want others (even someone who is intimately close with them) to know who they have called or have been called by, how often, and/or at what times. Users similarly do not want others to see the content or other information regarding text messages and other communications.

Erasing the data as soon as it is no longer needed is possible in some instances, but is not a desirable solution, nor is it possible when the device is not accessible. Password protection on a mobile device is another such solution, however keeping a device password protected at all times is not always feasible. For example, there are times when it is necessary to provide another person (a non-owner) such as a spouse or co-worker with working access to a mobile device, such as when the other person needs to borrow the mobile phone, the device owner is driving, and so on. At such times it is necessary to give the other person the password or give them the phone in an unlocked state.

Once another person has the mobile device unlocked, that person generally has access to the device's saved data. This includes phone logs, text messages, emails and so forth. Thus, the person in possession of the device can read messages, as well as see who has called, how often and when. Even when the device is locked, unless explicitly configured otherwise, current incoming communications in the form of rings and caller ID text, or audible sounds and SMS text, for example, can be heard and/or read by anyone close to the device.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which one or more privacy-related actions with respect to an incoming or outgoing communication are performed to assist users in maintaining privacy and/or anonymity. The action or actions may be performed based upon contact-related data associated with the communication, such as a privacy attribute set for a contact, or based upon the device operating in a private operating mode.

In one aspect, a privacy-related action comprises determining whether to store information related to a communication in a general data store or a private data store, or to not store the information. For private communications such as a telephone call or message to or from an entity (e.g., person, group or organization) corresponding to a private contact, the information is stored to a private, protected storage, e.g., logged to a password-protected phone log or saved as message content to as password protected data store, or discarded. For non-private communications, the information is saved in general unprotected storage.

In one aspect, a privacy-related action comprises not allowing a notification (e.g., visibly or audibly) for a private incoming communication. For non-private communications, the notification is allowed with respect to privacy (although it remains subject to other device notification rules). An outgoing communication may be blocked or modified (e.g., caller ID automatically turned off, changing the source of a text message to a generic sender, and so on) based upon privacy settings.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for enhancing privacy and anonymity on a mobile device with respect to handling incoming and outgoing communications.

FIG. 2 is a block diagram representing example components for enhancing privacy and anonymity on a mobile device with respect to blocking or allowing notifications of incoming communications.

FIG. 3 is a flow diagram showing example steps that may be performed to determine, based on privacy settings, whether to log telephone call information to a general log, a private log, or not at all.

FIG. 4 is a flow diagram showing example steps that may be performed to determine, based on privacy settings, whether to save messages to a general message store, a private message store, or not at all.

FIG. 5 is a flow diagram showing example steps that may be performed to determine, based on privacy settings, whether to allow a notification (e.g., audible and/or visible) for an incoming communication.

FIG. 6 is a block diagram representing an exemplary non-limiting computing system or operating environment, e.g., in the example of a mobile device, in which one or more aspects of various embodiments described herein can be implemented.

### DETAILED DESCRIPTION

Various aspects of the technology described herein are generally directed towards automatically hiding and/or not logging selected communications information in mobile devices, as well as not notifying and/or automatically rejecting incoming communications from specified contacts. In one implementation, this is accomplished by marking selected contacts in the device's contact list (including address book or such other data store) as private, or operating the device in a private mode. The communication history (e.g., social networking discussions, incoming/outgoing/missed calls, SMS, MMS, e-mail) of private contacts, or the communication history that occurred while operating in the private mode, are not logged or saved to a general data store, but (optionally) may be saved to a private data store for later private viewing.

It should be understood that any of the examples herein are non-limiting. For example, while the technology described herein provides benefits with mobile devices, any device that receives and sends communications may similarly benefit. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in privacy and device communications in general.

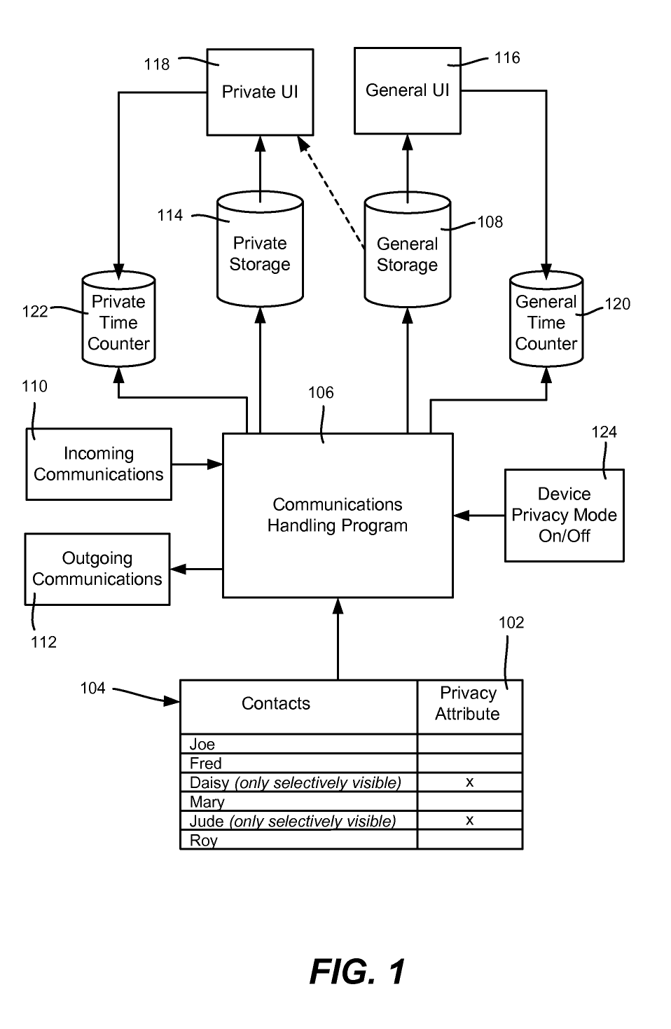

FIG. 1 shows example components of a mobile device configured to provide enhanced privacy and anonymity. In one implementation, a privacy attribute (in field 102) is associated with each contact or group of contacts. For purposes of brevity, a contacts list 104 containing contacts (including groups of contacts) is described in the examples herein, however it is understood that any similar data store (such as a customized address book) is an equivalent concept. In an alternative implementation, private contacts may be separately maintained from non-private contacts, e.g., in a protected database, and accessed only when appropriate.

In one implementation, when the user sets up the contacts list 104, the user is able to set (or clear) the privacy attribute for each contact. The user is also able to set (or clear) the privacy attribute for each contact when editing this information, or for any contact that is added. A private application and/or private operating mode within the contacts application, which may have protected access (e.g. require a password to operate), may be provided to allow such interaction; for example, the contacts application will not display any private contacts unless running in a private-access mode. This may be accomplished by modifying an existing contacts application to recognize the privacy attribute and act accordingly, or by having a separate store for private contacts, which may be merged with non-private contacts by a separate, private contacts application. For example, contacts may be maintained in a ‘black’ or ‘white’ list or the like, with such a list examined upon an incoming/outgoing communication to determine whether to take a privacy-related action. In FIG. 1, those contacts with the privacy attribute set (or by having been merged from a separate private list) are indicated as being only selectively visible.

In general and as described below, a communications handling program 106 (such as a telephony application, SMS application, email application, instant messaging application, social networking application and so forth) handles incoming communications according to the privacy attribute. For example, as represented in FIG. 1, the communications handling program 106 may be configured to not write any information to the program's general storage 108 with respect to any incoming communication 110 from a contact that is marked private, or with respect to any outgoing communication 112 to a contact that is marked private. For example, for an incoming (answered or missed) or outgoing telephone call from or to a private contact, no record of that call is logged to the program's general storage 108 (i.e., the call log for a telephone application). Instead, the communications handling program 106 logs the call into private storage 114 (if permitted by the user).

In this manner, no one can see the communications from a private contact by accessing the program's general storage 108 via the program's general user interface 116. To view the private storage, a separate, private user interface is used, which in general is protected, e.g., via a password. Note that the private user interface 118 may read the general storage 108 as well, such as to provide a merged call history or set of merged messages (e.g., sorted by timestamp, contact and so forth) if desired.

In one implementation, the user can control the privacy level and settings on a per-application basis. For example, a user may choose to not log calls or save SMS messages to their respective general storage, but may allow email messages to be saved to general email folders regardless of the contact's privacy setting. Note that this may be accomplished by a setting in each application, although it is also feasible to have a separate contact privacy attribute for each such application.

Also represented in FIG. 1 is the concept of separate general and private time counters 120 and 122 with respect to logged minutes used. For example, without separate counters on a device that logs telephone calls along with the time and duration of the calls, a non-owner of the device may be able to deduce that the device was used for 180 minutes of telephone calls, with only 120 minutes appearing in the general log, suggesting 60 minutes have been concealed. With separate counters, the general minutes match the general log, however via the (same or another) private user interface, the owner can see the total minutes, including a private versus general breakdown, for example.

Turning to another aspect, a device may be operated in a privacy mode in which communications with any contacts while in this mode are treated as if each contact had the privacy attribute set. To this end, the user may turn on or turn off a device privacy mode setting 124, e.g., via a device setting, application or in some other way (e.g., via a button or key combination). Access to this setting 124 may be protected (e.g., by a password). In this mode, any calls regardless of the contact attribute are logged to the private log, any SMS messages are saved in the private SMS storage, and so forth (if allowed), if the respective application is configured to do so for private contacts.

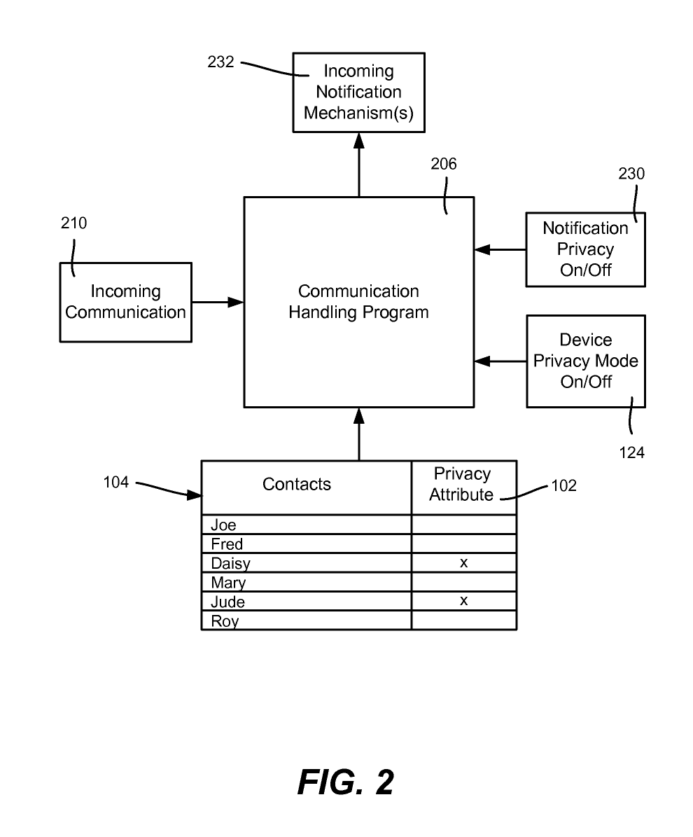

FIG. 2 illustrates another aspect, namely privacy-based automatic rejecting of incoming communications, without notification (e.g., ringing) of incoming communications. In one implementation, this feature may be turned on or off for the device, as represented in FIG. 2 by the notification privacy On/Off setting 230; this feature also may be turned on or off on a per-application basis.

When an incoming communication 210 is received, the communication handling program 206 checks the setting 230 to determine whether the feature is on or off, and if on, checks the privacy attribute of the contact and/or the device privacy mode setting 124 to determine whether to reject the incoming communication and provide no notification of it. If not private, the usual operations occur, e.g., an audible/visible notification is provided, as represented in FIG. 2 via block 232. If private, no notification is provided, and the incoming message may be rejected; (private storage such logging or saving the communication may be separately allowed).

In addition to blocking notifications for private communications, one or more other actions may be taken. For example, a telephone call from a private caller, when notifications are off, may be given a different (or no) voice mail message; a text message may be automatically sent in response to a call or another text message, and so forth.

Another way to use privacy attributes or a private device operating mode is with outgoing communications. For example, redialing to a private contact may be blocked, so that a non-owner cannot call the last number dialed to find out who answers. Any regular (e.g., non-password protected) communications to a private contact may be blocked so that a non-owner sender cannot pretend to be the owner that is calling or sending a message. The outgoing communication may be allowed but with modified data, e.g., caller ID may be automatically turned off, a text message can be sent with an anonymous sender (by routing through the email system instead of SMS, or other means) and so forth.

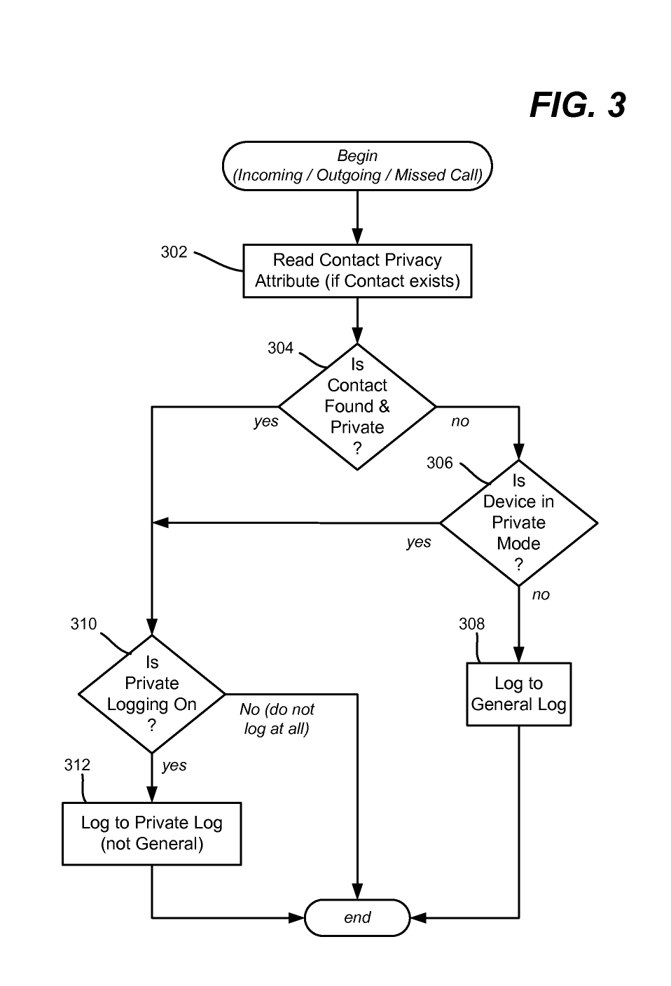

FIG. 3 is a flow diagram which represents example steps/logic that may be incorporated into a telephone-based program to provide privacy and anonymity as described herein with respect to an incoming or outgoing telephone call. Note that the privacy logic of FIG. 3 may be turned on or off per application, whereby the example steps of FIG. 3 may be bypassed if turned off for the telephone application, for example. Further note that different privacy logging (and possibly other) rules may apply to incoming answered, incoming missed and/or outgoing calls, however for purposes of this example, there is no differentiation between such types of calls.

When a call is detected, step 302 represents reading the privacy attribute corresponding to the contact for that call, if any corresponding contact exists; (note that a call may be to or from a number that does not have a saved contact). For an incoming call, or an outgoing call which was not made via the contacts list, step 302 generally includes using the telephone number to look up the contacts data.

Step 304 represents evaluating the privacy attribute of the contact (if any exists) to determine whether the corresponding contact of the caller or callee is marked private. If not found or not private, step 306 represents evaluating the device attribute to determine whether the device has been set to the private mode. If neither, step 308 logs the call information to the general log, and this processing part of the telephone application ends. Note that steps 304 and 306 may be performed in the reverse order, e.g., if it is more efficient to check the privacy mode before looking up a contact.

If the contact is determined to exist and is set to private (step 304), or the device is determined to be in the private mode (step 306), then the call will not be logged in the general log. Step 310 determines whether private logging is allowed; if so the call is logged into the private log at step 312, otherwise it is not logged at all.

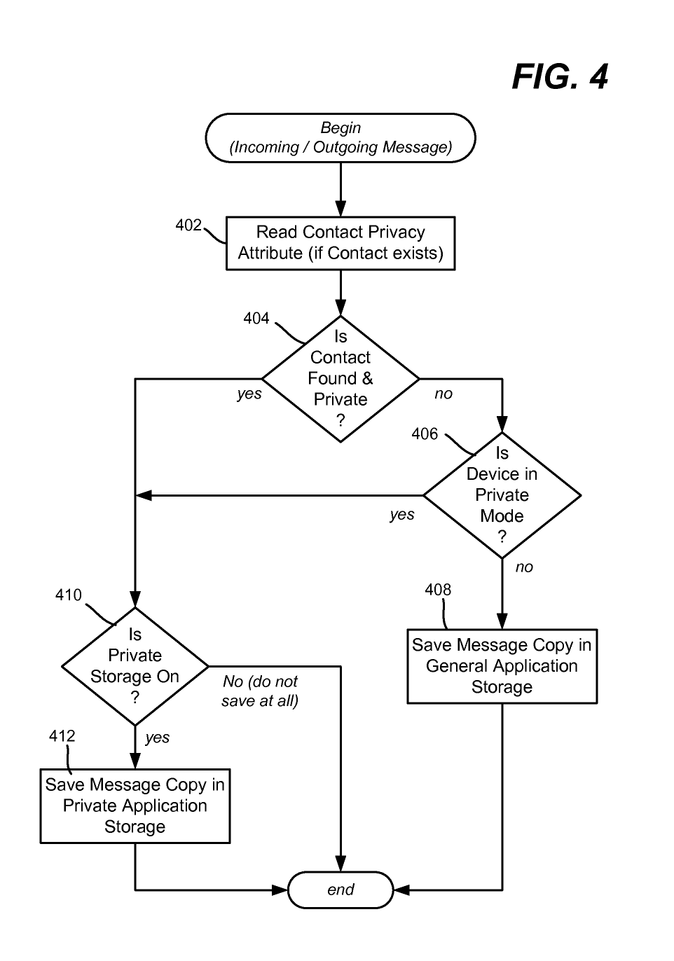

FIG. 4 is a flow diagram (with logic similar to FIG. 3) which represents example steps that may be incorporated into a message-based program to provide privacy and anonymity as described herein with respect to an incoming or outgoing message. Note that the privacy logic of FIG. 4 may be turned on or off per application, whereby the example steps of FIG. 4 thus illustrate those that may be taken when privacy is turned on. Further note that different privacy storage rules may apply to incoming versus outgoing messages, however for purposes of this example, there is no differentiation between such types of messages.

When a message is detected, step 402 represents reading the privacy attribute corresponding to the contact for that message, if any corresponding contact exists; (note that a communication may be to or from an entity that does not have a saved contact). For an email or instant message, for example, step 402 generally includes using the address of the sender (if incoming) or recipient (if outgoing) to look up the contacts data. For an incoming SMS message, or an outgoing SMS message which was not made via the contacts list, step 402 generally includes using the telephone number to look up the contacts data.

Step 404 represents evaluating the privacy attribute of the contact (if any exists) to determine whether the corresponding contact is private. If not private or not found, step 406 represents evaluating the device attribute to determine whether the device has been set to the private mode. If neither, step 408 saves the message in the application's general message store, and this processing part of the messaging application ends. Note that steps 404 and 406 may be performed in the reverse order, e.g., if it is more efficient to check the privacy mode before looking up a contact.

If the contact is determined to exist and is set to private (step 404), or the device is determined to be in the private mode (step 406), then the message will not be stored in the general message storage for this application. Step 410 determines whether private storage is allowed; if so the message is stored into the private messaging storage for this application.

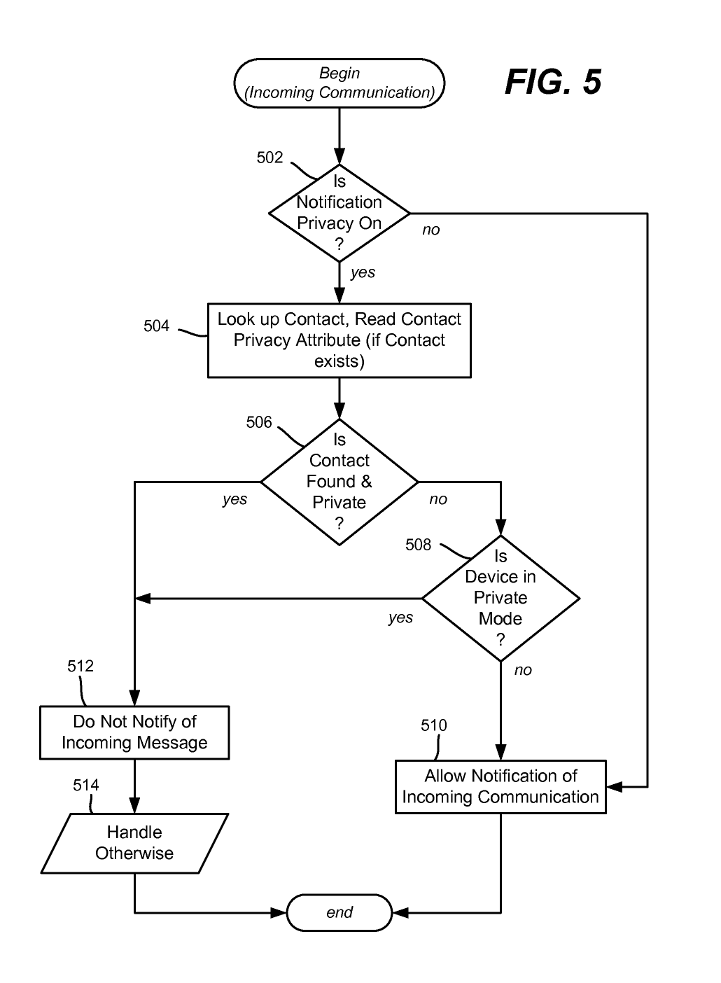

FIG. 5 is a flow diagram which represents example steps that may be incorporated into any program that handles incoming communications with respect to providing notifications. Note that as with other privacy aspects, the application may override device-wide settings, e.g., private telephone calls may generate notifications, but not private text messages. Further, the device itself may be in an audible, vibrate or silent mode, which controls any actual notification that may be provided.

When an incoming communication is detected, the steps of FIG. 5 represent determining whether the device is set to allow or not allow notifications based on privacy. Note that it is feasible to have different types of notifications allowed while other types are prevented, e.g., block ringing and visible notifications but allow vibrate, and so on, however for simplicity, FIG. 5 shows either allowing or preventing notifications as a whole.

To this end, step 502 checks the device privacy mode On/Off setting 230 represented in FIG. 2. If this feature is not on, the user does not want notifications blocked (regardless of who initiated the incoming communication), and step 502 branches to step 510 where the notification is allowed (at least with respect to privacy concerns). Note that whether and how the privacy-allowed notification occur, if at all, may be subject to other device settings, e.g., the notification will not ring for a phone call when the device is in silent mode, SMS text will not pop up on the display if the user has otherwise prevented this previewing feature, a received email will not make any sound if the user has set the device to not produce any sound for a received email, and so on.

If the notification privacy feature is on at step 502, step 504 looks up to determine whether there is a contact associated with the caller or message sender, including reading the privacy attribute corresponding to the contact if a contact exists. For an SMS message or phone call, for example, this generally includes using the sender's/caller's telephone number to look up the contacts data. For an email or instant message, for example, this generally includes using the sender's address to look up the contacts data.

Step 506 represents evaluating whether the contact attribute exists and is set as private. If not, step 508 represents evaluating the device privacy mode setting 124 to determine whether the device has been set to the private mode. If neither, step 510 allows the notification of the communication to pass privacy-based blocking, as generally described above.

If the contact is determined to exist and is set to private (step 506), or the device is determined to be in the private mode (step 508), then the notification will be prevented, as generally represented via step 512. Step 514 represents further processing, such as to perform private storage/logging or not, to change voice mail, send an automated reply, and so forth as generally exemplified above.

As can be seen, numerous benefits and advantages are provided by protecting privacy with respect to communications. Other ways to protect privacy include marking applications and content as private, (e.g., bought or acquired while in the private mode or later designated as private). Purchases and purchase history of applications, downloads, goods, services and so forth may be likewise marked as private so they do not appear visible to a user with non-elevated privileges, for example. Rules such as to automatically mark private certain purchases (e.g., any purchase over $5.00) also may be used.

### Exemplary Operating Environment

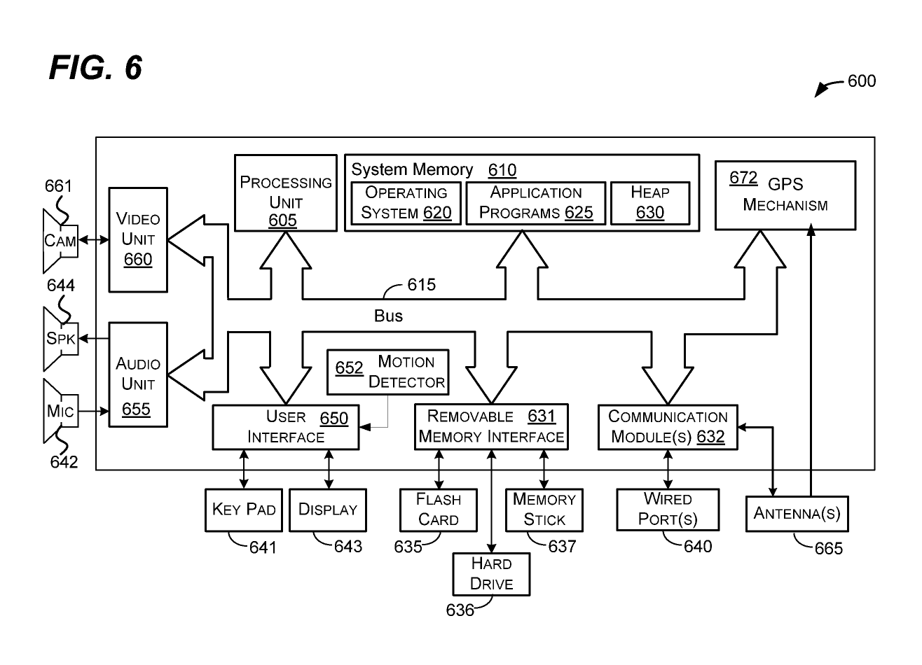

FIG. 6 illustrates an example of a suitable mobile device 600 on which aspects of the subject matter described herein may be implemented. The mobile device 600 is only one example of a device and is not intended to suggest any limitation as to the scope of use or functionality of aspects of the subject matter described herein. Neither should the mobile device 600 be interpreted as having any dependency or requirement relating to any one or combination of components illustrated in the exemplary mobile device 600.

With reference to FIG. 6, an exemplary device for implementing aspects of the subject matter described herein includes a mobile device 600. In some embodiments, the mobile device 600 comprises a cell phone, a handheld device that allows voice communications with others, some other voice communications device, or the like. In these embodiments, the mobile device 600 may be equipped with a camera for taking pictures, although this may not be required in other embodiments. In other embodiments, the mobile device 600 comprises a personal digital assistant (PDA), hand-held gaming device, notebook computer, printer, appliance including a set-top, media center, or other appliance, other mobile devices, or the like. In yet other embodiments, the mobile device 600 may comprise devices that are generally considered non-mobile such as personal computers, servers, or the like.

Components of the mobile device 600 may include, but are not limited to, a processing unit 605, system memory 610, and a bus 615 that couples various system components including the system memory 610 to the processing unit 605. The bus 615 may include any of several types of bus structures including a memory bus, memory controller, a peripheral bus, and a local bus using any of a variety of bus architectures, and the like. The bus 615 allows data to be transmitted between various components of the mobile device 600.

The mobile device 600 may include a variety of computer-readable media. Computer-readable media can be any available media that can be accessed by the mobile device 600 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 600.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 610 includes computer storage media in the form of volatile and/or nonvolatile memory and may include read only memory (ROM) and random access memory (RAM). On a mobile device such as a cell phone, operating system code 620 is sometimes included in ROM although, in other embodiments, this is not required. Similarly, application programs 625 are often placed in RAM although again, in other embodiments, application programs may be placed in ROM or in other computer-readable memory. The heap 630 provides memory for state associated with the operating system 620 and the application programs 625. For example, the operating system 620 and application programs 625 may store variables and data structures in the heap 630 during their operations.

The mobile device 600 may also include other removable/non-removable, volatile/nonvolatile memory. By way of example, FIG. 6 illustrates a flash card 635, a hard disk drive 636, and a memory stick 637. The hard disk drive 636 may be miniaturized to fit in a memory slot, for example. The mobile device 600 may interface with these types of non-volatile removable memory via a removable memory interface 631, or may be connected via a universal serial bus (USB), IEEE 6394, one or more of the wired port(s) 640, or antenna(s) 665. In these embodiments, the removable memory devices 635-637 may interface with the mobile device via the communications module(s) 632. In some embodiments, not all of these types of memory may be included on a single mobile device. In other embodiments, one or more of these and other types of removable memory may be included on a single mobile device.

In some embodiments, the hard disk drive 636 may be connected in such a way as to be more permanently attached to the mobile device 600. For example, the hard disk drive 636 may be connected to an interface such as parallel advanced technology attachment (PATA), serial advanced technology attachment (SATA) or otherwise, which may be connected to the bus 615. In such embodiments, removing the hard drive may involve removing a cover of the mobile device 600 and removing screws or other fasteners that connect the hard drive 636 to support structures within the mobile device 600.

The removable memory devices 635-637 and their associated computer storage media, discussed above and illustrated in FIG. 6, provide storage of computer-readable instructions, program modules, data structures, and other data for the mobile device 600. For example, the removable memory device or devices 635-637 may store images taken by the mobile device 600, voice recordings, contact information, programs, data for the programs and so forth.

A user may enter commands and information into the mobile device 600 through input devices such as a key pad 641 and the microphone 642. In some embodiments, the display 643 may be touch-sensitive screen and may allow a user to enter commands and information thereon. The key pad 641 and display 643 may be connected to the processing unit 605 through a user input interface 650 that is coupled to the bus 615, but may also be connected by other interface and bus structures, such as the communications module(s) 632 and wired port(s) 640. Motion detection 652 can be used to determine gestures made with the device 600.

A user may communicate with other users via speaking into the microphone 642 and via text messages that are entered on the key pad 641 or a touch sensitive display 643, for example. The audio unit 655 may provide electrical signals to drive the speaker 644 as well as receive and digitize audio signals received from the microphone 642.

The mobile device 600 may include a video unit 660 that provides signals to drive a camera 661. The video unit 660 may also receive images obtained by the camera 661 and provide these images to the processing unit 605 and/or memory included on the mobile device 600. The images obtained by the camera 661 may comprise video, one or more images that do not form a video, or some combination thereof.

The communication module(s) 632 may provide signals to and receive signals from one or more antenna(s) 665. One of the antenna(s) 665 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 672. In turn, the GPS mechanism 672 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 600 may connect to one or more remote devices. The remote devices may include a personal computer, a server, a router, a network PC, a cell phone, a media playback device, a peer device or other common network node, and typically includes many or all of the elements described above relative to the mobile device 600.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, performing one or more privacy-related actions with respect to an incoming or outgoing communication based upon contact data associated with the communication, or based upon operating in a private operating mode.

2. The method of claim 1 wherein performing the one or more privacy-related actions comprises determining whether to store information related to that communication in a general data store or a private data store.

3. The method of claim 1 wherein performing the one or more privacy-related actions comprises determining whether to store information related to that communication in a general data store, in a private data store, or to not store the information.

4. The method of claim 1 further comprising, reading a privacy attribute associated with the contact data to determine that the one or more privacy-related actions are to be performed.

5. The method of claim 1 wherein the communication is an incoming communication, and wherein performing the one or more privacy-related actions comprises determining whether to allow a notification of the incoming communication.

6. The method of claim 5 wherein determining whether to allow the notification of the incoming communication comprises evaluating whether a notification privacy feature is in an on state or an off state.

7. The method of claim 1 wherein the communication corresponds to a telephone call to or from a contact having contact data designated as private, or made or received while in the private operating mode, and wherein performing the one or more privacy-related actions comprises logging information related to that telephone call in a private call log.

8. The method of claim 1 wherein the communication corresponds to a telephone call, and wherein performing the one or more privacy-related actions comprises maintaining a private time counter that logs duration data for telephone calls that are determined to be private based upon based upon the contact data associated with the telephone caller or callee, or based upon operating in a private operating mode during the telephone call.

9. The method of claim 1 wherein the communication corresponds to a telephone call, and wherein performing the one or more privacy-related actions comprises determining whether to log information related to that telephone call in a general call log, to a private call log, or to not log the information.

10. The method of claim 1 wherein the communication corresponds to a message, and wherein performing the one or more privacy-related actions comprises determining that the message is associated with contact data that is private, and storing message content in private program storage.

11. The method of claim 1 wherein the communication corresponds to a message, and wherein performing the one or more privacy-related actions comprises determining whether to store message content in a general program storage, or in a private program storage, or to not store the message content.

12. The method of claim 1 wherein performing the one or more privacy-related actions comprises storing information related to that communication in a private data store, and further comprising, providing a protected user interface for interacting with the information in the private data store.

13. The method of claim 1 wherein performing the one or more privacy-related actions comprises blocking an outgoing communication or modifying data associated with an outgoing communication.

14. In a computing environment, a system comprising, a communications handling program configured to evaluate privacy-related data with respect to an incoming or outgoing communication to determine when a communication is private, and when the communication is determined to be private, to store information into a private storage that is accessible through a protected private user interface.

15. The system of claim 14 wherein the communications handling program corresponds to a telephony application, an SMS application, an MMS application, an instant messaging application, an email application, or a social networking application.

16. The system of claim 14 wherein the privacy-related data comprises attribute information associated with a contact, or a private operating mode setting.

17. The system of claim 14 wherein the communications handling program is further configured to block a notification when the communication is determined to be private.

18. One or more computer-readable media having computer-executable instructions, which when executed perform steps, comprising, accessing privacy data associated with an entity that corresponds to a communication, determining whether the privacy data indicates that the communication is to be handled privately, and if so, handling the communication privately by maintaining information associated with the communication in a private storage or by not maintaining information associated with the communication.

19. The one or more computer-readable media of claim 18 wherein accessing the privacy data associated with an entity that corresponds to a communication comprises locating a privacy attribute associated with a message sender, a message recipient, a telephone caller or a telephone callee.

20. The one or more computer-readable media of claim 18 wherein the communication comprises an incoming communication, and having further computer-executable instructions comprising, handling the communication privately by preventing a notification of the incoming communication.
